(19) United States
(12) Patent Application Publication
(10) Pub. No.: US 2009/0040565 A1
(43) Pub. Date: Feb. 12, 2009

(54) SYSTEMS, METHODS AND APPARATUS FOR HEALTHCARE IMAGE RENDERING COMPONENTS

(75) Inventors: Fausto Jose Espinal, Waukesha, WI (US); David Matthew Deaven, Delafield, WI (US); John D. Hoford, Pewaukee, WI (US)

Correspondence Address: RAMIREZ & SMITH, PO BOX 341179, AUSTIN, TX, 78734, US

(73) Assignee: GENERAL ELECTRIC COMPANY, Schenectady, NY (US)

(21) Appl. No.: 11/836,058

(22) Filed: Aug. 8, 2007

(51) Int. Cl. H04N 1/387

(52) U.S. Cl. 358/452

(57) ABSTRACT

Systems, methods and apparatus are provided through which in some embodiments healthcare graphical image annotation classes are extensions of a standard user interface class.

### FIELD OF THE INVENTION

This invention relates generally to user interface software development tools, and more particularly to healthcare imaging software development user interface tools.

### BACKGROUND OF THE INVENTION

Healthcare image rendering can include transforming image pixels that are acquired from a healthcare scanning device into displayable images that are intended for use in the diagnosis of disease. Typical healthcare applications include graphical user interface (GUI) toolkit elements which are the building blocks of GUI displays with “widgets” such as text fields, scrollbars, radio buttons, and the like, combined with image “ports” which are also widgets, but whose displayable contents are configured using application program interfaces (APIs) particular to the rendering software development toolkit. Application developers typically think of the GUI toolkit elements and the software development toolkit as separate software tools having different APIs that the application developers can combine in order to create an application.

For example, some application developers use Java Swing, C++ MOTIF or some other commercially available toolkit to build the user interface panels of the application. The developers can then use some other toolkit such as OpenGL to create “ports” to draw the graphics displaying the displayable images. Developers often think of the commercially available toolkits and the other toolkits as using and interacting two completely different sub-systems or interfaces.

### BRIEF DESCRIPTION OF THE INVENTION

In one aspect, a computer-accessible medium includes a user-annotation visual component class that is operable to provide attributes and processes that support annotation of healthcare images by a user. Some embodiments of the computer-accessible medium also include a region-of-interest visual component class that is operable to provide attributes and processes that support description of regions-of interest in healthcare images. Some embodiments of the computer-accessible medium also include an image visual component class that is operable to provide attributes and processes that support imaging of healthcare images. Some embodiments of the computer-accessible medium also include an annotation visual component class that is operable to provide attributes and processes that support annotation of healthcare images. Each of the classes are extensions of a parent visual component class that defines processes that support geometric notations on images and defines processes that support scaled imaging described by healthcare patient coordinates of the image.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of an overview of a system of healthcare imaging components;

FIG. 2 is a flowchart of a method to generate a healthcare imaging application, according to an embodiment;

FIG. 3 is a block diagram of a class hierarchy of medical imaging classes, according to an embodiment;

FIG. 4 is a diagram of a visual image of a user annotated medical image according to an embodiment;

FIG. 5 is a diagram of a visual image of a system annotated medical image according to an embodiment;

FIG. 6 is a diagram of a visual image of an annotated medical image according to an embodiment;

FIG. 7 is a diagram of a visual image of a region-of-interest annotated medical image according to an embodiment;

FIG. 8 is a simplified diagram of an overview of an X-ray imaging system; and

FIG. 9 illustrates an example of a general computer environment useful in the context of the environment of FIG. 8, according to an embodiment.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The detailed description is divided into five sections. In the first section, a system level overview is described. In the second section, embodiments of methods are described. In the third section, particular implementations are described. In the fourth section, a hardware and the operating environment in conjunction with which embodiments may be practiced are described. Finally, in the fifth section, a conclusion of the detailed description is provided.

### System Level Overview

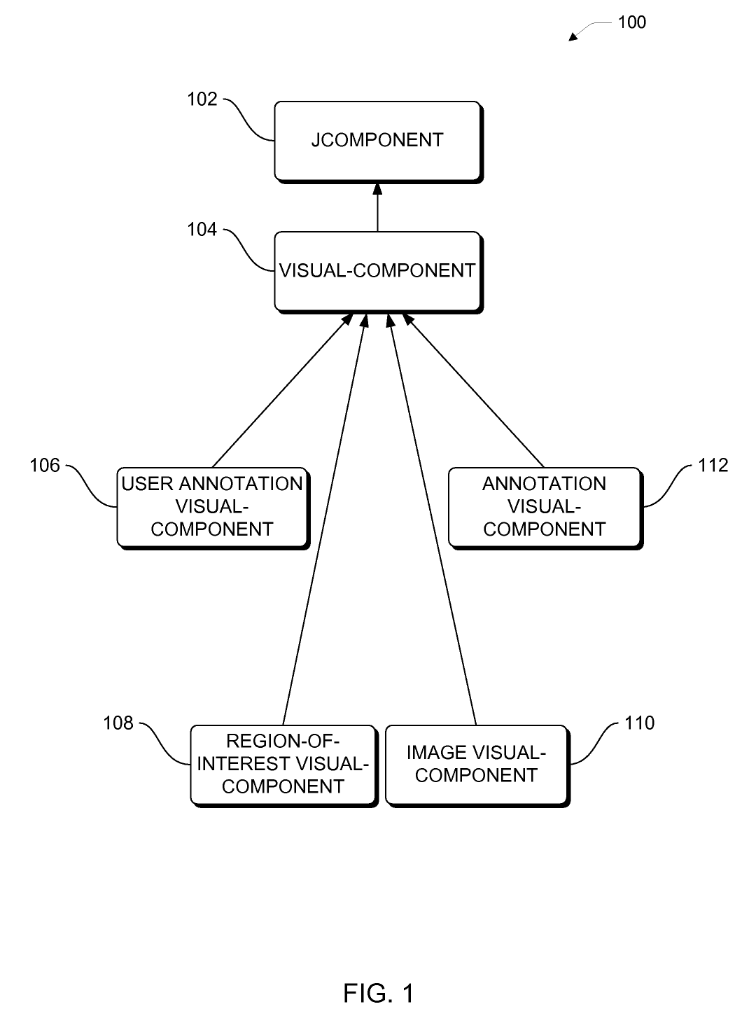

FIG. 1 is a block diagram of an overview of a system 100 of healthcare imaging classes. System 100 provides objects that are tailored or customized to perform image processing and presentation for healthcare diagnostics.

System 100 includes a JComponent object 102. The JComponent object 102 provides support for tool tips, borders, keyboard-generated actions, application-wide pluggable look and feel, properties, support for layout, support for accessibility, double buffering and methods to increase efficiency.

A Visual Component object 104 extends the JComponent object 102. The Visual Component object 104 provides methods that support geometric notations on images. The Visual Component object 104 also provides methods that support scaled imaging described by healthcare patient coordinates of the image.

At least one object extends the Visual Component object 104. For example, a user-annotation visual component object 106 extends the Visual Component object 104. In another example, a region-of-interest (ROI) visual component object 108 extends the Visual Component object 104. In yet another example, an image visual component object 110 extends the Visual Component object 104. In still another example, an annotation visual component object 112 extends the Visual Component object 104. The user-annotation visual component object 106, the region-of-interest (ROI) visual component object 108, the image visual component object 110 and the annotation visual component object 112 extend the Visual Component object 104.

Graphical objects 106, 108, 110 and 112 are operable to draw two-dimensional (2D) and/or three-dimensional (3D) healthcare image renderings. The images can be, but are not limited to image acquired by magnetic resonance imaging (MRI), computer tomography (CT), positron emission tomography (PET) and X-ray imaging.

The user-annotation visual component object 106 provides attributes and methods that support annotation of healthcare images by a user. The ROI visual component object 108 provides attributes and methods that support description of regions-of interest in healthcare images. The image visual component object 110 provides attributes and methods that support imaging of healthcare images. The annotation visual component object 112 provides attributes and methods that support annotation of healthcare images by software that uses system 100.

Using graphical objects 106, 108, 110 and 112, software developers can build applications with standard graphical user interface (GUI) toolkit interfaces/constructs, such as JComponent 102. The developers do not need to learn new graphical image toolkit systems, but instead the developers can work within standard GUI toolkits such as JAVA Swing. The ease of use in creating graphical applications improves the productivity of the developers by dramatically easing the learning curve.

System 100 is a tool that can be used in the creation of new types of user interfaces for imaging systems, which provide differentiated value. Integration of “standard UI” with a healthcare image display is important as electromagnetic resonance (EMR) systems are integrated into diagnostic imaging systems and workflow. The object components of system 100 support collaboration between users of a distributed software application.

System 100 and in particular graphical objects 106, 108, 110 and 112 have the effect of integrating and assimilating the notion of UI toolkit widgets (e.g. text fields, scrollbars, event callback functions, and layout managers as provided by JAVA Swing, Motif, etc . . . ) with typical healthcare imaging constructs such as images, medical annotation, and ROIs. These medical rendering constructs are manipulated and used just like any UI widget such as buttons, labels, and menus. Thus, a healthcare imaging application developer is exposed to a programming interface where building healthcare imaging applications essentially consists of laying out UI elements and programming the different interactions between the UI elements using familiar constructs of well-known commercial UI toolkits, such as JComponent 102.

Thus, system 100 and in particular graphical objects 106, 108, 110 and 112 provide multiple healthcare imaging visual components within a single “port” via standard graphical user interface application program interfaces (APIs), such that both “graphics” and “UI controls” elements are manipulated and interacted with indifferently by application developers.

System 100 and in particular graphical objects 106, 108, 110 and 112 implement standard UI layout managers to express complex compositions of medical imaging application features and display modes, such as “picture in a picture” reference images and geometrical cross-reference graphics.

System 100 and in particular graphical objects 106, 108, 110 and 112 implement standard UI event models to program interactive behaviors of medical imaging application features within a single application “port.”

While the system 100 is not limited to any particular JComponent object 102, Visual Component object 104, user-annotation visual component object 106, ROI visual component object 108, image visual component object 110 and annotation visual component object 112, for sake of clarity a simplified JComponent object 102, Visual Component object 104, user-annotation visual component object 106, ROI visual component object 108, image visual component object 110 and annotation visual component object 112 are described.

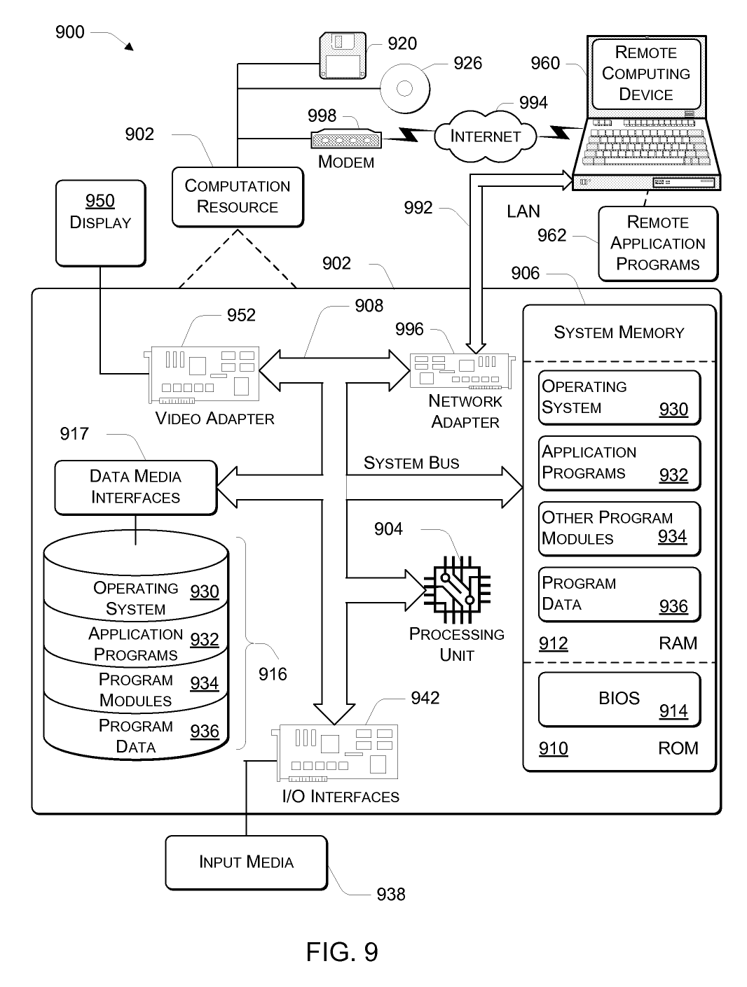

The system level overview of the operation of an embodiment is described above in this section of the detailed description. Some embodiments operate in a multi-processing, multi-threaded operating environment on a computer, such as computation resource 902 in FIG. 9.

### Method Embodiments

In the previous section, a system level overview of the operation of an embodiment is described. In this section, the particular methods of such an embodiment are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Method 200 is performed by a program executing on, or performed by firmware or hardware that is a part of, a computer, such as computer computation resource 902 in FIG. 9.

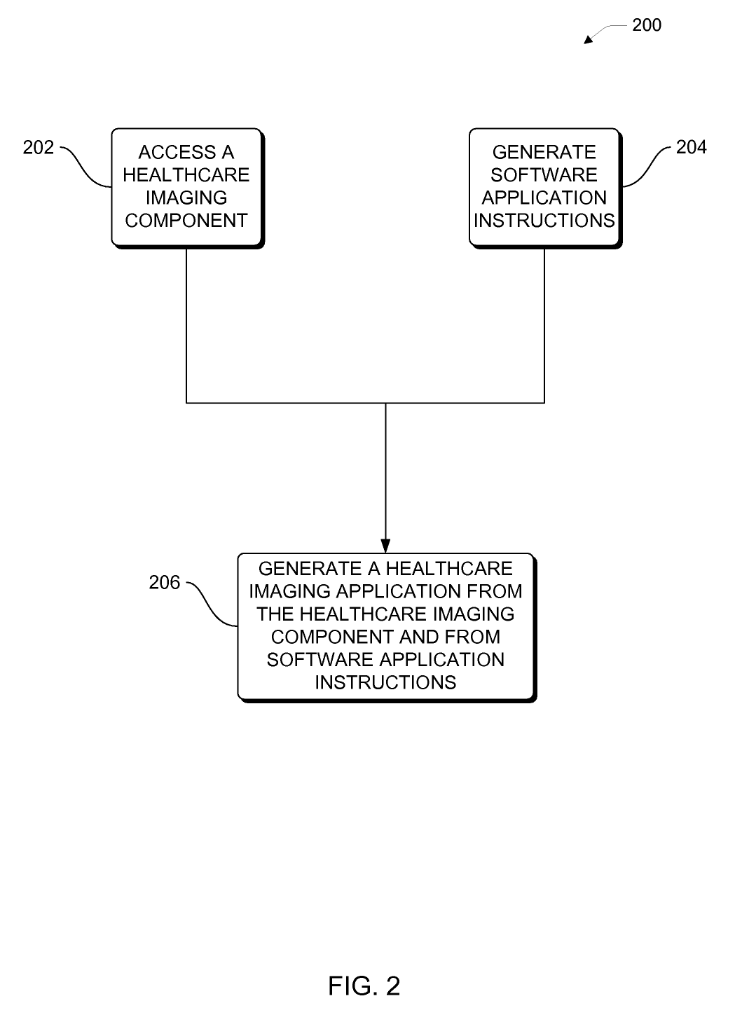

FIG. 2 is a flowchart of a method 200 to generate a healthcare imaging application, according to an embodiment. Method 200 provides sophisticated image processing capability.

Method 200 includes accessing a healthcare imaging component in a computer-accessible storage medium, at block 202. The healthcare imaging component is an extension of a standard user interface component, such as JComponent 102 in FIG. 1.

Some embodiments of method 200 also include generating the software application instructions at block 204 by writing computer program instructions that describe user interface elements in the software application instructions and by programming the different interactions between the user interface elements in the software application instructions that are stored in the computer-accessible storage medium. The software application instructions are stored to a computer-accessible storage medium.

Method 200 also includes generating a healthcare imaging application from the healthcare imaging component and from software application instructions, at block 206. The healthcare imaging application is generated to be stored to the computer-accessible storage medium.

In some embodiments, method 200 is implemented as a computer data signal embodied in a carrier wave, that represents a sequence of instructions which, when executed by a processor, such as processing unit 904 in FIG. 9, cause the processor to perform the respective method. In other embodiments, method 200 is implemented as a computer-accessible medium having executable instructions capable of directing a processor, such as processing units 904 in FIG. 9, to perform the respective method. In varying embodiments, the medium is a magnetic medium, an electronic medium, or an optical medium.

### Apparatus

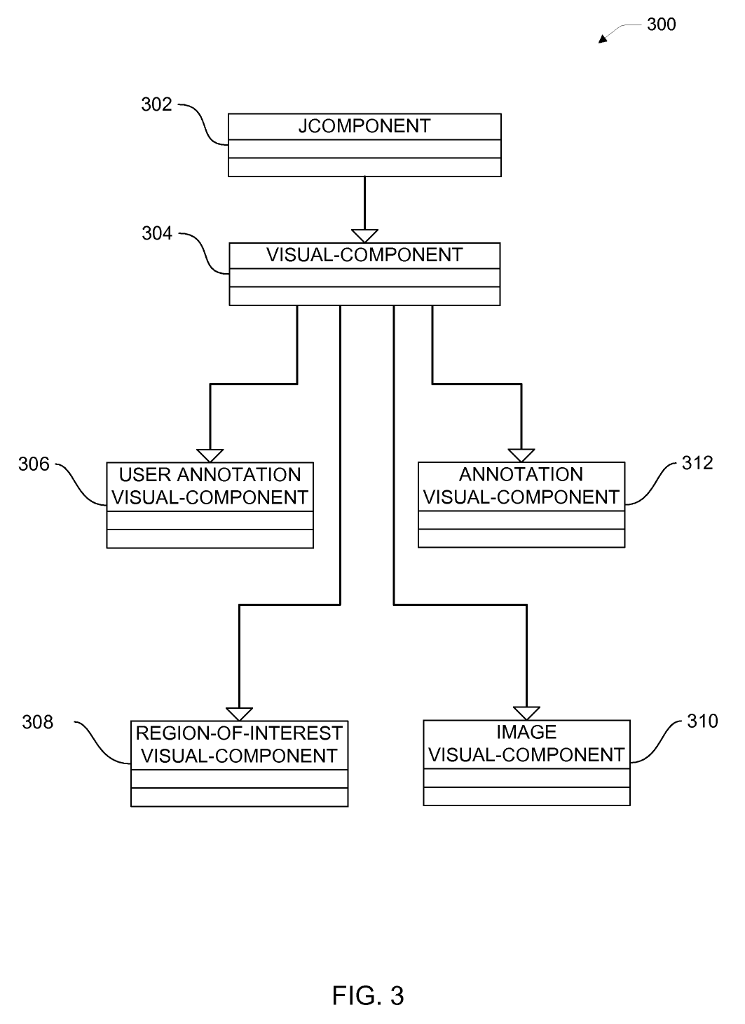

Referring to FIGS. 3-7, particular implementations are described in conjunction with the system overview in FIG. 1 and the method described in conjunction with FIG. 2.

FIG. 3 is a block diagram of a class hierarchy 300 of medical imaging classes, according to an embodiment. FIG. 3 uses the Unified Modeling Language (UML), which is the industry-standard language to specify, visualize, construct, and document the object-oriented artifacts of software systems. In the figures, a hollow arrow between classes is used to indicate that a child class below a parent class inherits attributes and methods from the parent class. In addition, a solid-filled diamond is used to indicate that an object of the class that is depicted above an object of another class is composed of the lower depicted object. Composition defines the attributes of an instance of a class as containing an instance of one or more existing instances of other classes in which the composing object does not inherit from the object(s) of which the composing object is composed.

Apparatus 300 includes a JComponent class 302. The JComponent class 302 provides support for tool tips, borders, keyboard-generated actions, application-wide pluggable look and feel, properties, support for layout, support for accessibility, double buffering and methods to increase efficiency. JComponent class 302 is described in Java™ Platform Standard Edition 6 published by Sun Microsystems, Inc. of Santa Clara, Calif.

A Visual Component class 304 extends the JComponent class 302. The Visual Component class 304 provides methods that support geometric notations on images. The Visual Component class 304 also provides methods that support scaled imaging described by healthcare patient coordinates of the image.

At least one class extends the Visual Component class 304. For example, a user-annotation visual component class 306 extends the Visual Component class 304. In another example, a region-of-interest (ROI) visual component class 308 extends the Visual Component class 304. In yet another example, an image visual component class 310 extends the Visual Component class 304. In still another example, an annotation visual component class 312 extends the Visual Component class 304. The user-annotation visual component class 306, the region-of-interest (ROI) visual component class 308, the image visual component class 310 and the annotation visual component class 312 extend the Visual Component class 304.

The user-annotation visual component class 306 provides attributes and methods that support annotation of healthcare images by a user. The ROI visual component class 308 provides attributes and methods that support description of regions—of interest in healthcare images. The image visual component class 310 provides attributes and methods that support imaging of healthcare images. The annotation visual component class 312 provides attributes and methods that support annotation of healthcare images by the apparatus 300.

While the apparatus 300 is not limited to any particular JComponent class 302, Visual Component class 304, user-annotation visual component class 306, ROI visual component class 308, image visual component class 310 and annotation visual component class 312, for sake of clarity a simplified JComponent class 302, Visual Component class 304, user-annotation visual component class 306, ROI visual component class 308, image visual component class 310 and annotation visual component class 312 are described.

The JComponent class 302 is an extension of the Container class (not shown). The Container class provides graphical elements that have subcomponents such as windows, panels, frames and dialog boxes. The Container class holds or organizes other objects such as trees, bags and vectors. The Container class includes support for adding components to Container class objects and provides support for laying-out components.

The Container class is an extension of the Component class (not shown). The Component class provides a graphical representation that can be displayed on the screen and that can interact with the user. Examples of components are the buttons, checkboxes, and scrollbars of a typical graphical user interface. The Component class is the abstract superclass of the nonmenu-related Abstract Window Toolkit components. The Component class provides support that includes providing layout hints and supporting painting and events.

Components of the system 100 and apparatus 300 and the actions of method 200 can be embodied as computer hardware circuitry or as a computer-readable program, or a combination of both. In another embodiment, system 100 and apparatus 300 and the actions of method 200 is implemented in an application service provider (ASP) system.

More specifically, in the computer-readable program embodiment, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computation resource 902 in FIG. 9, or on at least as many computers as there are components.

### Implementations

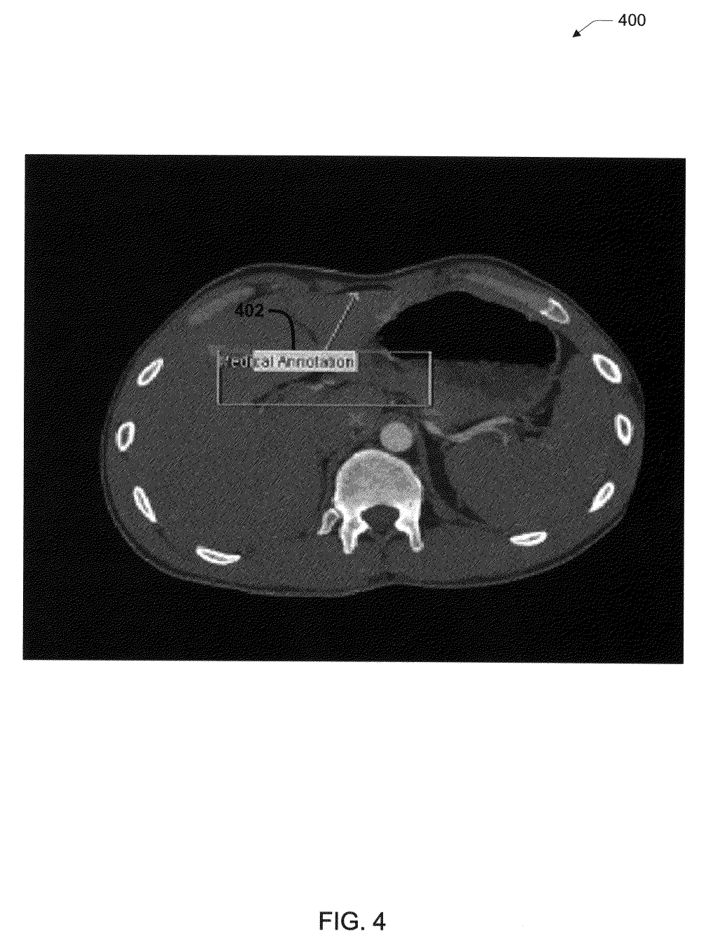

FIG. 4-7 illustrate examples of the product of system 100, method 200 and apparatus 300 described above.

FIG. 4 is a diagram of a visual image of a user annotated medical image 400, according to an embodiment. The annotated medical image 400 includes an annotation 402 that was generated by the user-annotation visual component object 106 in FIG. 1.

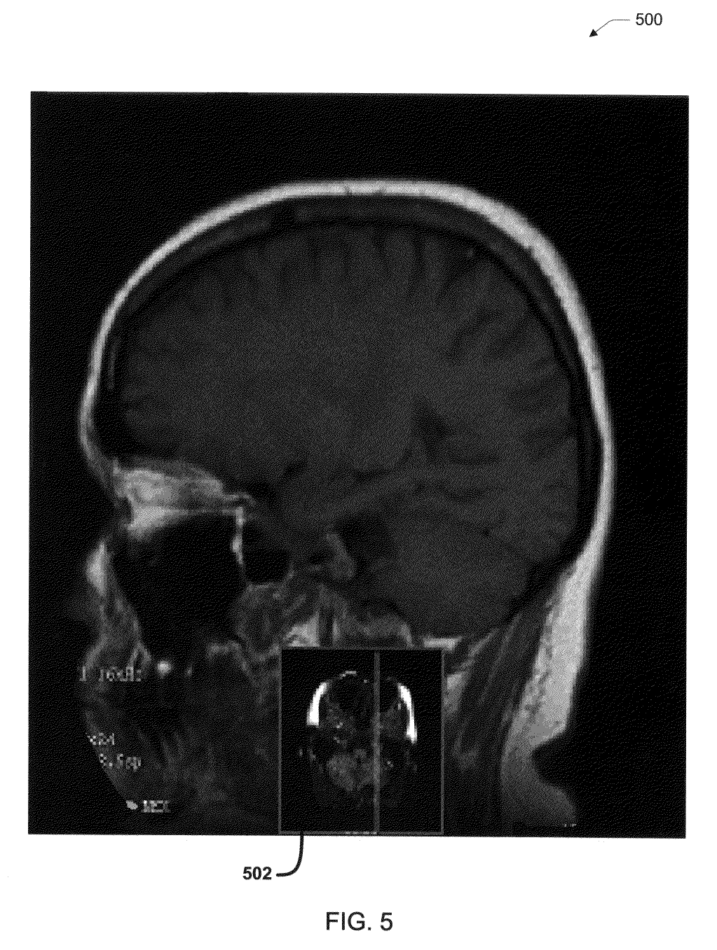

FIG. 5 is a diagram of a visual image of a system annotated medical image 500, according to an embodiment. The annotated medical image 500 includes an annotation 502 that was generated by the annotation visual component object 112 in FIG. 1.

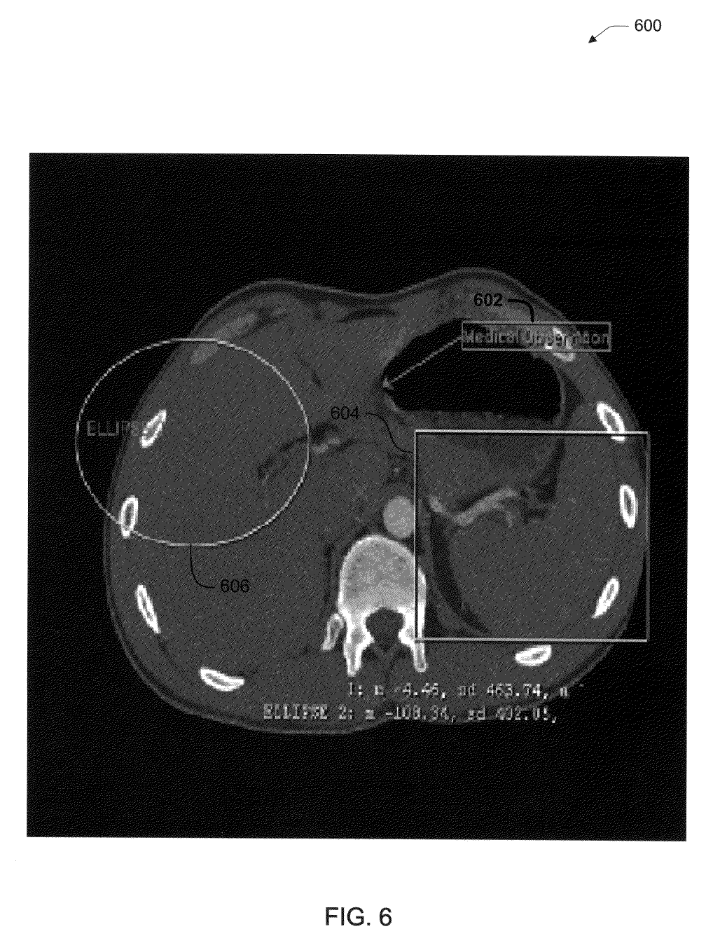

FIG. 6 is a diagram of a visual image of an annotated medical image 600, according to an embodiment. The annotated medical image 600 includes an annotation 602 that was generated by the annotation visual component object 112 in FIG. 1 and includes annotations 604 and 606 that were generated by the annotation visual component object 112 in FIG. 1.

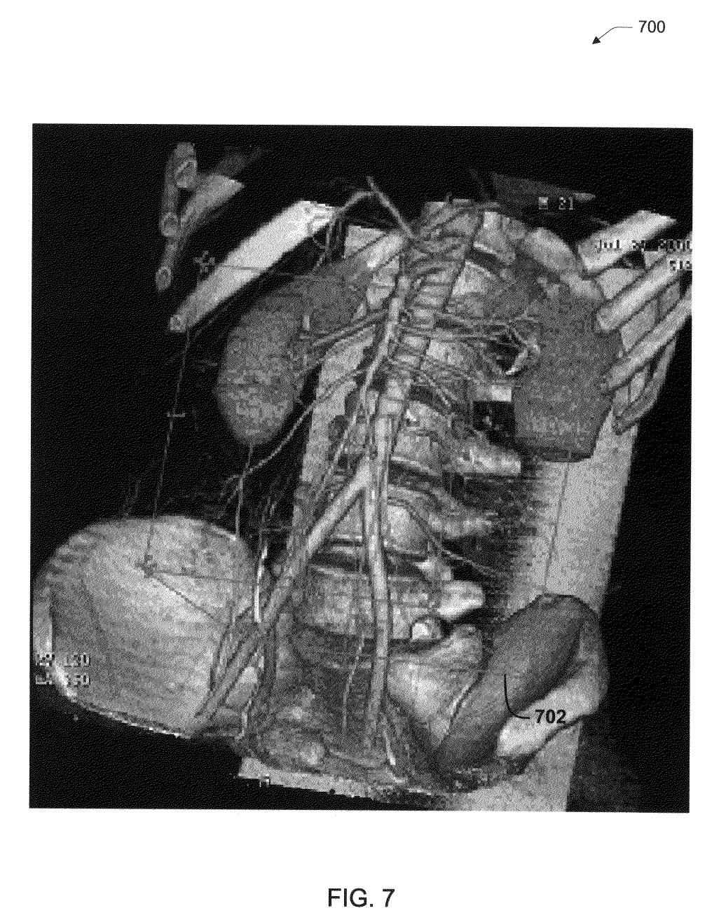

FIG. 7 is a diagram of a visual image of a region-of-interest annotated medical image 700, according to an embodiment. The annotated medical image 700 includes an annotation 702 that was generated by the region-of-interest (ROI) visual component object 108 in FIG. 1.

### Hardware and Operating Environment

The memory devices 850 include mass data storage capabilities 854 and one or more removable data storage device ports 856. The one or more removable data storage device ports 856 are adapted to detachably couple to portable data memories 858, which may include optical, magnetic and/or semiconductor memories and may have read and/or write capabilities, and which may be volatile or non-volatile devices or may include a combination of the preceding capabilities.

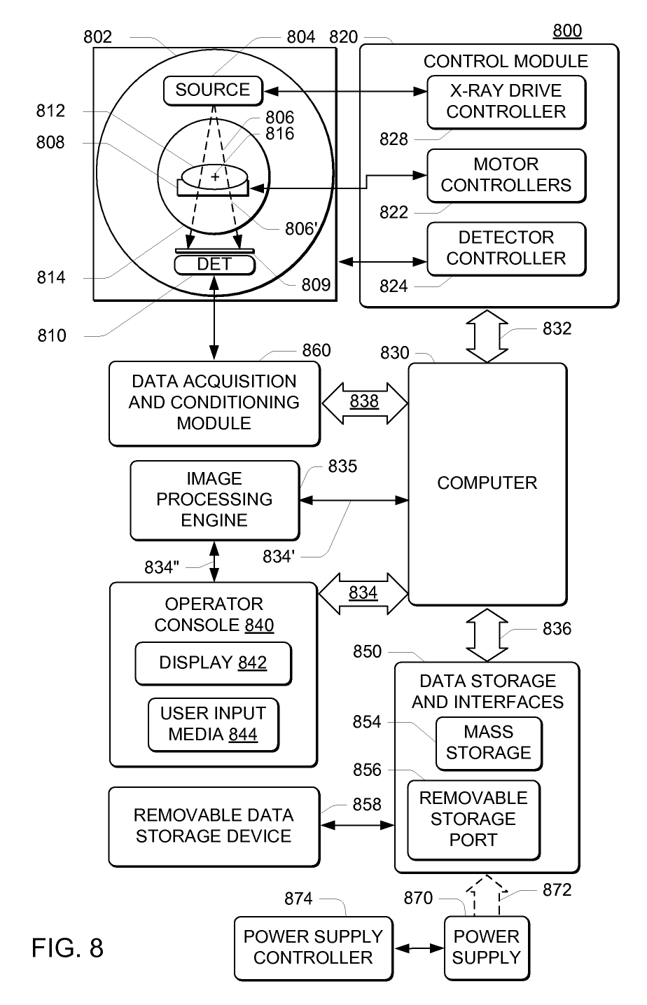

The system 800 further includes a data acquisition and conditioning module 860 that has data inputs coupled to the detector 810 and that is coupled by the bus 838 to the one or more computers 830. The data acquisition and conditioning module 860 includes analog to digital conversion circuitry for capturing analog data from the detector 810 and then converting those data from the detector 810 into digital form, to be supplied to the one or more computers 830 for ultimate display via at least one of the displays 842 and for potential storage in the mass storage device 854 and/or data exchange with remote facilities (not shown in FIG. 8). The acquired image data may be conditioned in either the data acquisition and conditioning module 860 or the one or more computers 830 or both.

The system 800 also includes a power supply 870, coupled via interconnections represented as a power supply bus 872, shown in dashed outline, to other system elements, and a power supply controller 874. In some embodiments, the system 800 is configured to be a mobile system equipped with a portable power supply 870, such as a battery. In other words, the system 800 may comprise a wheeled unit and may be electromotively powered in self-contained fashion, lending physical agility to the ensemble of attributes offered by the system 800.

FIG. 9 illustrates an example of a general computer environment 900 useful in the context of the environment of FIG. 8, according to an embodiment. The general computer environment 900 includes a computation resource 902 capable of implementing the processes described herein. It will be appreciated that other devices may alternatively used that include more components, or fewer components, than those illustrated in FIG. 9.

The illustrated operating environment 900 is only one example of a suitable operating environment, and the example described with reference to FIG. 9 is not intended to suggest any limitation as to the scope of use or functionality of the embodiments of this disclosure. Other well-known computing systems, environments, and/or configurations may be suitable for implementation and/or application of the subject matter disclosed herein.

The computation resource 902 includes one or more processors or processing units 904, a system memory 906, and a bus 908 that couples various system components including the system memory 906 to processor(s) 904 and other elements in the environment 900. The bus 908 represents one or more of any of several types of bus structures, including a memory bus or memory controller, a peripheral bus, an accelerated graphics port and a processor or local bus using any of a variety of bus architectures, and may be compatible with SCSI (small computer system interconnect), or other conventional bus architectures and protocols.

The system memory 906 includes nonvolatile read-only memory (ROM) 910 and random access memory (RAM) 912, which may or may not include volatile memory elements. A basic input/output system (BIOS) 914, containing the elementary routines that help to transfer information between elements within computation resource 902 and with external items, typically invoked into operating memory during start-up, is stored in ROM 910.

The computation resource 902 further may include a non-volatile read/write memory 916, represented in FIG. 9 as a hard disk drive, coupled to bus 908 via a data media interface 917 (e.g., a SCSI, ATA, or other type of interface); a magnetic disk drive (not shown) for reading from, and/or writing to, a removable magnetic disk 920 and an optical disk drive (not shown) for reading from, and/or writing to, a removable optical disk 926 such as a CD, DVD, or other optical media.

The non-volatile read/write memory 916 and associated computer-readable media provide nonvolatile storage of computer-readable instructions, data structures, program modules and other data for the computation resource 902. Although the exemplary environment 900 is described herein as employing a non-volatile read/write memory 916, a removable magnetic disk 920 and a removable optical disk 926, it will be appreciated by those skilled in the art that other types of computer-readable media which can store data that is accessible by a computer, such as magnetic cassettes, FLASH memory cards, random access memories (RAMs), read only memories (ROM), and the like, may also be used in the exemplary operating environment.

A number of program modules may be stored via the non-volatile read/write memory 916, magnetic disk 920, optical disk 926, ROM 910, or RAM 912, including an operating system 930, one or more application programs 932, other program modules 934 and program data 936. Examples of computer operating systems conventionally employed for some types of three-dimensional and/or two-dimensional healthcare image data include the NUCLEUS® operating system, the LINUX® operating system, and others, for example, providing capability for supporting application programs 932 using, for example, code modules written in the C++® computer programming language. The non-volatile read/write memory 916 and the system memory 906 are both examples of computer-accessible storage mediums.

A user may enter commands and information into computation resource 902 through input devices such as input media 938 (e.g., keyboard/keypad, tactile input or pointing device, mouse, foot-operated switching apparatus, joystick, touchscreen or touchpad, microphone, antenna etc.). Such input devices 938 are coupled to the processing unit 904 through a conventional input/output interface 942 that is, in turn, coupled to the system bus. A monitor 950 or other type of display device is also coupled to the system bus 908 via an interface, such as a video adapter 952.

The computation resource 902 may include capability for operating in a networked environment (as illustrated in FIG. 8, for example) using logical connections to one or more remote computers, such as a remote computer 960. The remote computer 960 may be a personal computer, a server, a router, a network PC, a peer device or other common network node, and typically includes many or all of the elements described above relative to the computation resource 902. In a networked environment, program modules depicted relative to the computation resource 902, or portions thereof, may be stored in a remote memory storage device such as may be associated with the remote computer 960. By way of example, remote application programs 962 reside on a memory device of the remote computer 960. The logical connections represented in FIG. 9 may include interface capabilities, e.g., such as interface capabilities 852 (FIG. 8) a storage area network (SAN, not illustrated in FIG. 9), local area network (LAN) 972 and/or a wide area network (WAN) 974, but may also include other networks.

Such networking environments are commonplace in modern computer systems, and in association with intranets and the Internet. In certain embodiments, the computation resource 902 executes an Internet Web browser program (which may optionally be integrated into the operating system 930), such as the “Internet Explorer®” Web browser manufactured and distributed by the Microsoft Corporation of Redmond, Wash.

When used in a LAN-coupled environment, the computation resource 902 communicates with or through the local area network 972 via a network interface or adapter 976. When used in a WAN-coupled environment, the computation resource 902 typically includes interfaces, such as a modem 978, or other apparatus, for establishing communications with or through the WAN 974, such as the Internet. The modem 978, which may be internal or external, is coupled to the system bus 908 via a serial port interface.

In a networked environment, program modules depicted relative to the computation resource 902, or portions thereof, may be stored in remote memory apparatus. It will be appreciated that the network connections shown are exemplary, and other means of establishing a communications link between various computer systems and elements may be used.

A user of a computer may operate in a networked environment 800 using logical connections to one or more remote computers, such as a remote computer 960, which may be a personal computer, a server, a router, a network PC, a peer device or other common network node. Typically, a remote computer 960 includes many or all of the elements described above relative to the computer 900 of FIG. 9.

The computation resource 902 typically includes at least some form of computer-readable media. Computer-readable media may be any available media that can be accessed by the computation resource 902. By way of example, and not limitation, computer-readable media may comprise computer storage media and communication media.

Computer storage media include volatile and nonvolatile, removable and non-removable media, implemented in any method or technology for storage of information, such as computer-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation resource 902.

Communication media typically embodies computer-readable instructions, data structures, program modules or other data, represented via, and determinable from, a modulated data signal, such as a carrier wave or other transport mechanism, and includes any information delivery media. The term “modulated data signal” means a signal that has one or more of its characteristics set or changed in such a manner as to encode information in the signal in a fashion amenable to computer interpretation.

By way of example, and not limitation, communication media include wired media, such as wired network or direct-wired connections, and wireless media, such as acoustic, RF, infrared and other wireless media. The scope of the term computer-readable media includes combinations of any of the above.

The computer 902 may function as one or more of the control segments of module 820 (FIG. 8), the computer 830, the operator console 840 and/or the data acquisition and conditioning module 860, for example, via implementation of the processes 200, respectively, as one or more computer program modules.

### Conclusion

A healthcare imaging software development system is described. A technical effect of the system, methods and apparatus described herein is generation of software that annotate medical images. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in object-oriented terms, one of ordinary skill in the art will appreciate that implementations can be made in a procedural design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application is meant to include all object-oriented, imaging and healthcare environments and alternate technologies which provide the same functionality as described herein.

We claim:

1. A computer-accessible medium comprising:
a user-annotation visual component class that is operable to provide attributes and processes that support annotation of healthcare images by a user;
a region-of-interest visual component class that is operable to provide attributes and processes that support description of regions-of interest in healthcare images;
an image visual component class that is operable to provide attributes and processes that support imaging of healthcare images; and
an annotation visual component class that is operable to provide attributes and processes that support annotation of healthcare images,
wherein each of the classes are extensions of a parent visual component class that defines processes that support geometric notations on images and defines processes that support scaled imaging described by healthcare patient coordinates of the image.

2. The computer-accessible medium of claim 1, wherein the parent visual component class further comprises:
an extension of a standard user interface component.

3. The method of claim 2, wherein the standard user interface component further comprises:
a JComponent class.

4. The computer-accessible medium of claim 1, wherein the visual component classes implement standard user interface event models to program interactive behaviors of medical imaging application features within a single application port.

5. The computer-accessible medium of claim 1, wherein the visual component classes implement standard user interface layout managers to express complex compositions of medical imaging application features and display modes.

6. The computer-accessible medium of claim 5, wherein the medical imaging application features and display modes further comprise:
picture in a picture reference images and geometrical cross-reference graphics.

7. The computer-accessible medium of claim 1, wherein the visual component classes provide multiple healthcare imaging visual components within a single port via standard graphical user interface application program interfaces.

8. A method to generate a healthcare imaging application, the method comprising:
accessing a healthcare imaging component in a computer-accessible storage medium, wherein the healthcare imaging component is an extension of a standard user interface component; and
generating a healthcare imaging application from the healthcare imaging component and from software application instructions, generating the healthcare imaging application to the computer-accessible storage medium.

9. The method of claim 8 further comprising generating the software application instructions wherein generating the software application instructions further comprises:
describing user interface elements in the software application instructions; and
programming the different interactions between the user interface elements in the software application instructions that are stored in the computer-accessible storage medium, and
wherein the method further comprises:
storing the software application instructions.

10. The method of claim 8, wherein the standard user interface component further comprises:
JComponent.

11. The method of claim 8, wherein the healthcare imaging component further comprises:
a user-annotation visual component object that is operable to provide attributes and processes that support annotation of healthcare images by a user.

12. The method of claim 8, wherein the healthcare imaging component further comprises:
a region-of-interest visual component object that is operable to provide attributes and processes that support description of regions-of interest in healthcare images.

13. The method of claim 8, wherein the healthcare imaging component further comprises:
an image visual component object that is operable to provide attributes and processes that support imaging of healthcare images.

14. The method of claim 8, wherein the healthcare imaging component further comprises:
an annotation visual component object that is operable to provide attributes and processes that support annotation of healthcare images.

15. The method of claim 8, wherein the healthcare imaging component further comprises at least one object selected from the groups of objects consisting of
a user-annotation visual component object that is operable to provide attributes and processes that support annotation of healthcare images by a user,
a region-of-interest visual component object that is operable to provide attributes and processes that support description of regions-of interest in healthcare images,
an image visual component object that is operable to provide attributes and processes that support imaging of healthcare images, and
an annotation visual component object that is operable to provide attributes and processes that support annotation of healthcare images.

16. A medical imaging system comprising:
a processor;
a storage device coupled to the processor; and
software apparatus on the storage device comprising:
a user-annotation visual component object that is operable to provide attributes and processes that support annotation of healthcare images by a user;
a region-of-interest visual component object that is operable to provide attributes and processes that support description of regions-of interest in healthcare images;
an image visual component object that is operable to provide attributes and processes that support imaging of healthcare images; and
an annotation visual component object that is operable to provide attributes and processes that support annotation of healthcare images,
wherein each of the objects are extensions of a parent visual component object that is operable to provide processes that support geometric notations on images and is operable to provide processes that support scaled imaging described by healthcare patient coordinates of the image.

17. The medical imaging system of claim 16, wherein the parent visual component object further comprises:
an extension of a standard user interface component.

18. The medical imaging system of claim 16, wherein the standard user interface component further comprises:
a JComponent object.

19. The medical imaging system of claim 16, wherein the visual component objects implement standard user interface event models to program interactive behaviors of medical imaging application features within a single application port.

20. The medical imaging system of claim 16, wherein the visual component objects implement standard user interface layout managers to express complex compositions of medical imaging application features and display modes.

21. The medical imaging system of claim 16, wherein the visual component objects provide multiple healthcare imaging visual components within a single port via standard graphical user interface application program interfaces.
